(19) United States
(12) Patent Application Publication
(10) Pub. No.: US 2014/0379407 A1
(43) Pub. Date: Dec. 25, 2014

(54) Automatic Scheduling of Future Appointments through Partially Constrained Calendar Rules

(71) Applicant: TimeTrade Systems, Inc., Tewksbury, MA (US)

(72) Inventor: Tyler Horton, Tewksbury, MA (US)

(21) Appl. No.: 14/310,079

(22) Filed: Jun. 20, 2014

Related U.S. Application Data
(60) Provisional application No. 61/837,677, filed on Jun. 21, 2013.

(51) Int. Cl. G06Q 10/10

(52) U.S. Cl. CPC G06Q 10/1095
USPC 705/7.19

(57) ABSTRACT

A calendar system receives partially constrained calendar rules from a user at a current time for a calendar appointment to be scheduled at a future start time. The system determines, as the current time advances, whether constraints based on the calendar rules are met. If it is determined that the constraints are not met, the system delays scheduling of the calendar appointment until it is determined that the constraints are met. If it is determined that the constraints are met, the system automatically schedules the calendar appointment at the flexible future start time based on the met constraints and the calendar rules.

### CROSS REFERENCE TO RELATED APPLICATION

This application claims priority to U.S. Provisional Application No. 61/837,677 filed Jun. 21, 2013, the entirety of which is incorporated herein by reference.

### TECHNICAL FIELD

The present disclosure relates to flexible, automated, calendar appointment scheduling.

### BACKGROUND

Meeting/appointment scheduling is a way in which a service provider can interact with its clients/customers. Online/web-based appointment scheduling has become a prevalent tool used to allow a user to book appointments with service providers. Conventional scheduling requires that a user provide fixed, inflexible parameters defining the appointment, such as start time, a duration, a location, and so on, and then immediately booking or scheduling the appointment, i.e., committing time in the future for that appointment based on the fixed parameters. Such fixed, inflexible scheduling cannot conveniently accommodate intervening scheduling events, such as other appointments, that may arise between the time the appointment is initially scheduled and the scheduled future time for the appointment, even when the user may wish to be flexible regarding the scheduled time for the appointment.

### SUMMARY

Presented herein are techniques to schedule a future, flexible, appointment automatically based on partially constrained calendar rules. The appointment may be scheduled with different characteristics when certain constraints based on the partially constrained calendar rules are met. A calendaring system receives partially constrained calendar rules from a user at a current time for a calendar appointment to be scheduled at a future start time. The system determines, as the current time advances, whether constraints based on the calendar rules are met. If it is determined that the constraints are not met, the system delays scheduling of the calendar appointment until it is determined that the constraints are met. If it is determined that the constraints are met, the system automatically schedules the calendar appointment at the flexible future start time based on the met constraints and the calendar rules.

### BRIEF DESCRIPTION OF THE DRAWINGS

FIG. 1 is a block diagram of an example system configured to allow the creation and implementation of a partially constrained calendar appointment for future scheduling of the appointment.

FIG. 2 illustrates an example user interface used to create a partially constrained calendar appointment.

FIG. 3 is an illustration of an example user interface used to confirm the creation of a partially constrained calendar appointment defined according to user entries/selections made through the user interface of FIG. 2.

FIG. 4 is a flow chart that depicts an example method of creating a partially constrained calendar appointment based on partially constrained calendar rules and scheduling a future appointment when a constraint based on the partially constrained rules is met.

FIG. 5 is a block diagram of a server configured to perform the techniques described herein, according to an example embodiment.

### DETAILED DESCRIPTION OF EXAMPLE EMBODIMENTS

Online/web-based appointment scheduling systems can greatly improve the efficiency of interaction between service providers and their clients/customers. Often, a customer may be somewhat flexible regarding parameters of a given future appointment, such as when the appointment may occur, where the appointment may occur, or a duration of the appointment. On the other hand, clients of the customer who wish to schedule appointments with the customer may not be flexible as to the when, where, or duration of the appointment. Techniques presented herein permit the customer (referred to herein as the “user”) to create a partially constrained future appointment using partially constrained rules or constraints. The partially constrained rules are a combination of flexible and inflexible calendar rules, which result in a flexible appointment. Partially constrained rules that may be used to characterize an activity to be scheduled include a commitment to complete an action within a specified range of time, a statement of presence at a specified location or one of a set of possible locations, and/or an option to conduct an activity for a variable length of time.

Once created, the partially constrained (flexible) appointment is not actually scheduled until a constraint based on the combination of flexible and inflexible rules is met. When the constraint is met, the appointment is automatically scheduled based on the constraint and the rules. This process is referred to herein as automatic scheduling of a future appointment through partially constrained calendar rules.

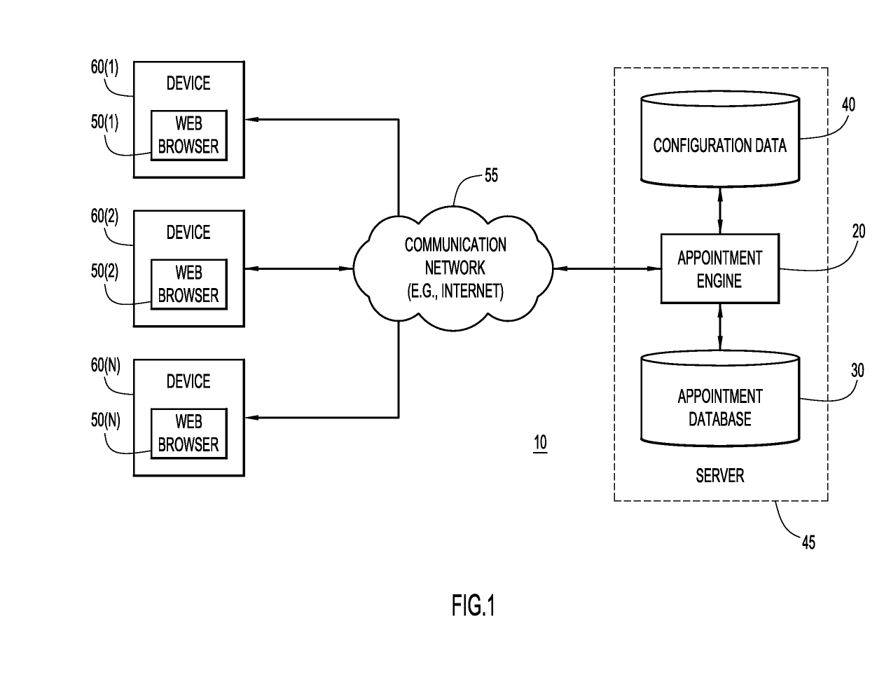

FIG. 1 shows an arrangement of a calendar system in which automatic scheduling of a future appointment through partially constrained calendar rules may be performed. The system, shown generally at reference numeral 10, includes an appointment engine 20 that executes appointment computer programs, an appointment database 30, and a data repository 40 that stores configuration data. As described hereinafter, the appointment engine 20, appointment data 30 and data repository 40 may be managed/run by one or more applications on a server 45. The appointment engine 20 communicates with web browsers 50(1)-50(N) by way of a communication network, e.g., the Internet, shown at reference numeral 55. A different user is associated with each of the web browsers 50(1)-50(N). Moreover, the web browsers 50(1)-50(N) are running within user devices 60(1)-60(N), respectively. Data for appointments is stored in the appointment database 30. The operations of the server 45 may be performed by one or more applications running in a data center/cloud computing environment. While the example calendar system of FIG. 1 is web-based, it is to be understood that the automatic scheduling techniques described herein may also be implemented as a non web-based or stand-alone calendar system. Such a stand-alone calendar system may be implemented as a stand-alone computer program application executed on a personal computer-based platform, such as a laptop computer or tablet, Smartphone, and the like.

At a high-level, a user creates a partially constrained calendar appointment using one or more graphical user interfaces (GUIs) presented through a given web browser (e.g., web browser 50(1)). For example, using web browser 50(1), the user enters and/or selects calendar rules or constraints for a future appointment including (i) meeting parameters, such as a meeting time, a duration, and a place, and (ii) flexibility indicators each associated with a corresponding one of the meeting parameters to indicate whether that meeting parameter is considered flexible or inflexible. An appointment defined based on both flexible and inflexible constraints is a partially constrained appointment. Data representative of the GUIs described herein may be generated at the web browsers 50 and/or server 45, as would be appreciated by one of ordinary skill in the relevant arts.

Described below are an example scenario in which a user wishes to create a partially constrained, flexible, calendar appointment, and two example event chronologies that lead to different associated scheduling outcomes. After these examples, a generalized method of creating and implementing a partially constrained calendar appointment will be presented.

In the example scenario, the user who wishes to create a partially constrained calendar appointment that will enable the user to take a lunch break of 30 minutes in the future beginning at a flexible start time somewhere between 12:00 pm and 2 pm (i.e., in a two hour time range between 12 and 2 pm). That is, the user wishes to create an appointment for a flexible 30 minute lunch break. Also, the user has clients who may wish to schedule appointments with the user during that 12 to 2 pm time range, but the clients may not have flexible time like the user. Because the user is flexible but the clients are not regarding appointment start times, the user does not wish to commit to (i.e., schedule) a 30 minute time slot in the time range in advance (i.e., ahead of time), but would rather wait-and-see what other client appointments may show-up in the time range.

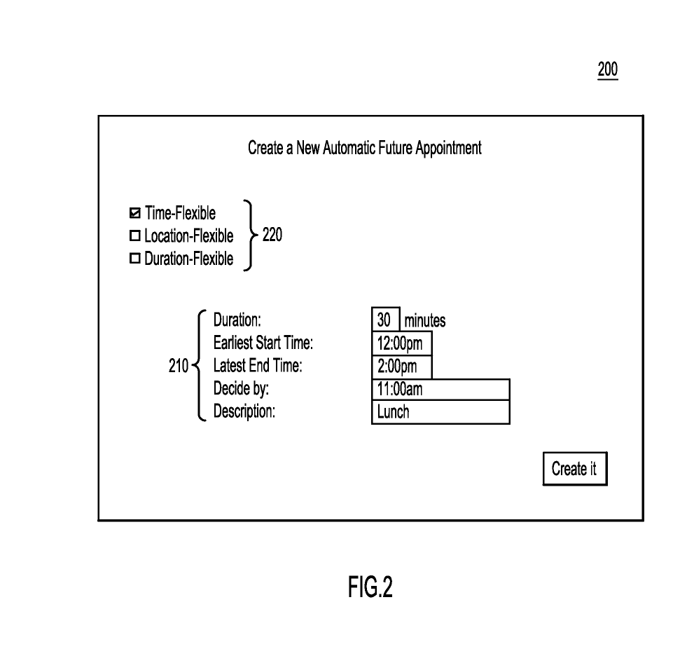

To accommodate the flexible and inflexible time constraints of the user and clients, respectively, the user creates a partially constrained calendar appointment using an administrative interface (described below in connection with FIG. 2) that will allow the clients to schedule time with the user arbitrarily between 12 and 2 pm until the constraint of having only one 30 minute slot remaining in that time range has been met, at which point the 30 minute user appointment is automatically scheduled (i.e., booked) into that remaining 30 minute slot, i.e., the future start time for the lunch appointment is automatically set at the beginning of the remaining 30 minute time slot. As used herein, the terms “schedule” and “book” are interchangeable and synonymous.

With reference to FIG. 2, there is shown an example administrative user interface 200 used to create the partially constrained appointment configured to handle the flexible lunch break example mentioned above. Content for user interface 200 may be generated by server 45 and provided by the server to, e.g., web browser 50(1). Web browser 50(1) presents, i.e., displays, user interface 200 to the user. Through user interface 200, the user enters and/or selects partially constrained appointment constraints or rules that define the partially constrained appointment through which the 30 minute lunch break is to be actually scheduled at some future time.

The appointment constraints include appointment parameters 210, such as: (i) an appointment duration, a time range between an earliest start time and a latest end time, an appointment description, and a time by which the appointment must be scheduled, although this is optional; and (ii) flexibility descriptors 220, which set corresponding ones of the meeting parameters to flexible or inflexible. In the example of FIG. 2, the start time of the appointment is set to be flexible (i.e., it may occur at different points in the time range 12-2 pm), while both the location and the duration are set to be inflexible. Other combinations of flexible and inflexible parameters may be set in other examples. The combination of flexible and inflexible constraints makes the appointment partially constrained.

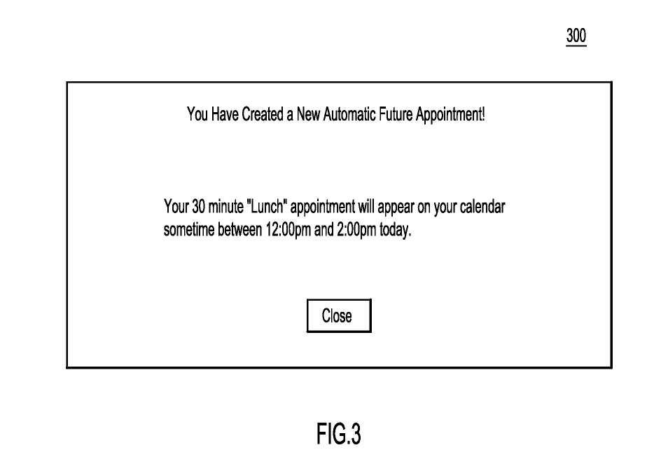

Once the user has selected/entered the appointment constraints via user interface 200, the user clicks on the “create it” button in the bottom right-hand corner of the user interface, which causes browser 50(1) to submit the information to server 45. Server 45 creates a partially constrained appointment based on the submitted information, i.e., the partially constrained rules. When the partially constrained appointment is initially created, the time range 12-2 pm is considered unscheduled and available for appointments. Server 45 generates information for an appointment confirmation and sends the information to web browser 50(1), which presents the appointment confirmation, as illustrated in FIG. 3.

With reference to FIG. 3, there is shown an example user interface 300 that confirms a partially constrained future appointment has been created based on the appointment constraints/rules provided by the user through user interface 200.

Once the partially constrained appointment has been created, server 45 monitors current time from a real-time-clock and accepts client appointments to be scheduled in the time range between 12 and 2 pm. As the current time progresses relative to the partially constrained appointment time range 12-2 pm, and as client appointments are scheduled into the time range of 12 to 2 pm thus converting portions of the unscheduled time in the time range into scheduled time (for the client appointments), server 45 repeatedly evaluates whether the constraint of having only one 30 minute time slot remaining (i.e., only 30 minutes of unscheduled time) in that time range has been met. If the constraint has not been met, server 45 holds-off on scheduling the 30 minute lunch appointment. If the constraint is met, server 45 automatically schedules the lunch appointment into the remaining 30 minute slot, i.e., the server fixes or schedules the future start time for the lunch appointment at the beginning of the remaining 30 minute time slot.

Provided below is a first example chronology of events leading to an automatic appointment creation based on the partially constrained calendar rules for the scenario described above. It is assumed that appointments may be scheduled in multiples of 15 minute time slots that begin on the hour, quarter hour, half hour, and three quarter hour.

At 11:00 am—The user creates the partially constrained future appointment, based on the selections/entries depicted in FIG. 2.

At 11:43 am—A client books an hour with the user from 12 pm to 1 pm. This converts 1 hour of unscheduled time to scheduled (now unavailable time). At this point, the system (i.e., server 45) is aware that one full hour unscheduled time slot remains (1 pm-2 pm) within which the user's lunch may be automatically scheduled. The constraint of only one remaining 30 minute time slot has not been met, so the system holds-off on automatically scheduling the lunch appointment.

At 12:22 pm—Another client books a 15-minute appointment with the user from 1 pm-1:15 pm. The system again takes no action due to there being multiple choices for when the user can take the 30-minute lunch before 2 pm.

At 1:04 pm—Another client books a 15-minute appointment with the user, this time from 1:45-2 pm. At this point the system determines that only one time slot remains available for a 30-minute lunch appointment, so the system automatically books the lunch appointment for 30 minutes from 1:15 pm-1:45 pm and adds it to the user's calendar.

Provided below is a second example chronology of events leading to an automatic appointment creation. The system is set up with the same parameters as before, but now nobody books time with the user as the day (current time) progresses.

At 9:00 am—The user creates the partially constrained future appointment (as depicted in FIG. 2).

At 1:16 pm—The system determines that the current time has advanced so far into the time range 12-2 pm that even though no clients scheduled time with the user (in the time range) throughout the day, there is not enough unscheduled time left in the time range for both the lunch appointment and an additional 15-minute appointment. Therefore the system now automatically schedules the 30 minute appointment for the lunch appointment from 1:30 pm-2:00 pm and adds it to the user's calendar.

In one embodiment, the system offers an option to the user to specify a trigger time when the system is to evaluate constraints and schedule an appointment. In the example of FIG. 2, the trigger time is referred to as a “Decide by” time, which is set at 11:00 am. In another example, the trigger time may be set at a time just before 12:00 pm so that the system evaluates constraints just before 12:00 pm. In another example, the trigger time may be set to a last possible moment, i.e., the option selected by the user may state and effect the following: “make the appointment at the last possible moment that the system would expect that the constraints would still be met”).

As described above, the system automatically schedules a flexible appointment when certain constraints are met. In another embodiment, the system offers an option to automatically un-schedule a previously scheduled flexible appointment if the system detects that one of the previously met constraints (that caused the appointment to be previously scheduled) is removed or invalidated. Consider an example in which a user desires an hour lunch appointment some time between 12 pm and 2 pm. Using the automatic scheduling described above, the system schedules the hour lunch appointment from 1-2 pm the moment that a client schedules an appointment with the user from 12-1 pm. If the same client later cancels the 12-1 pm appointment with the user, the system un-schedules the previously scheduled 12-1 pm user lunch appointment given that the lunch appointment could now conceivable occur at any time between 12 and 2 pm. The un-schedule action returns the system to its original state to offer full scheduling flexibility to clients.

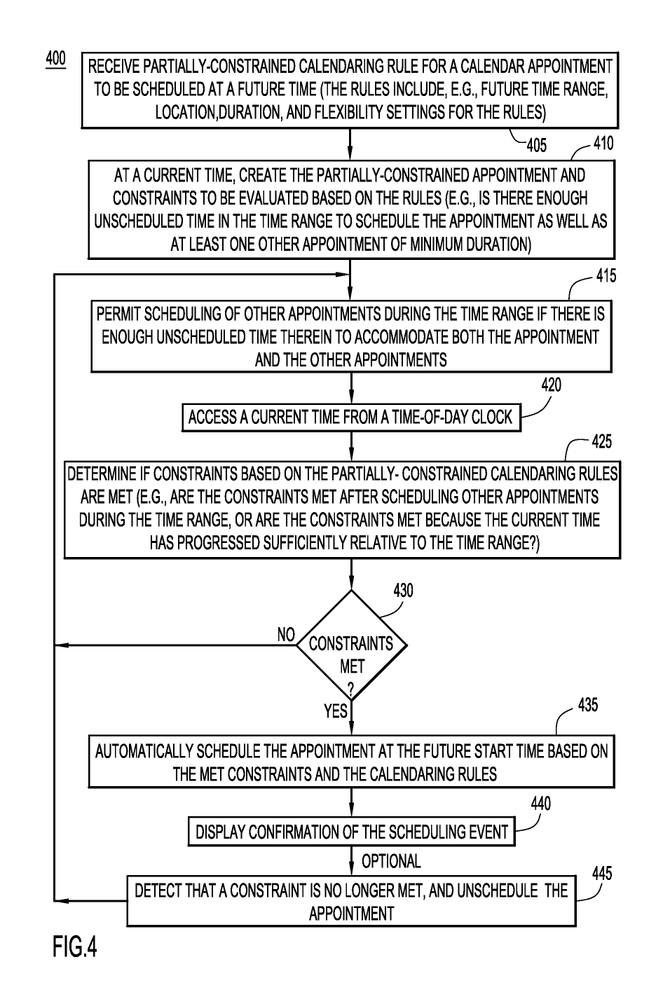

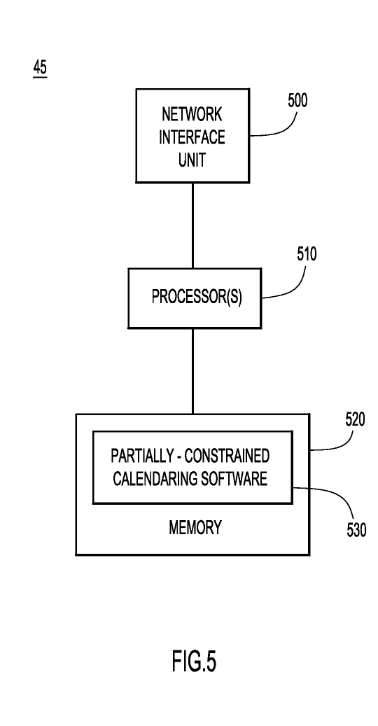

FIG. 4 illustrates a flow chart for a method 400 of creating and implementing a partially constrained calendar appointment and automatically scheduling a future appointment based on partially constrained rules. Initially, a user is presented with a user interface, such as user interface 200 described above, through which the user enters/selects partially constrained calendar rules for creating a partially constrained appointment. Software residing on server 45 (depicted in FIG. 5) performs the operations described below.

At 405, server 45 receives the partially constrained calendar rules entered/selected by the user for the partially constrained calendar appointment (the appointment of interest) to be scheduled at a future time. The rules include, e.g., a future time range during which the appointment must occur, a location for the appointment, a duration for the appointment, and flexibility settings for the rules. The flexibility settings set at least one of the time range, the location, and the duration to be flexible while the others are set to be inflexible. In an example, the time range is greater than the duration so that the time range may accommodate both the appointment of interest and other appointments.

At 410, at a current time, server 45 creates the partially constrained appointment and a constraint to be evaluated based on the associated partially constrained rules. When server 45 initially creates the partially constrained appointment, the entire time range represents initially unscheduled time that is available to be scheduled at a future time. In an example, the constraint to be evaluated may be, as current time progresses, whether there is enough unscheduled time remaining in the time range to schedule both the appointment of interest and at least one other appointment of minimum duration, e.g., an additional 15 minute appointment, or whether there is only enough unscheduled time remaining in the time range to schedule only the appointment (e.g., the remaining unscheduled time is less than the sum of the appointment duration and the minimum appointment time (e.g., 15 minutes)).

At 415, server 45 permits scheduling of other appointments during the time range if there is enough unscheduled time therein to accommodate both the appointment of interest and the other appointments. As the other appointments are scheduled, the unscheduled time in the time range is converted to scheduled time that is no longer available for the appointment of interest.

At 420, server 45 access a current time from a time-of-day clock.

At 425, server 45 determines if the constraint is met. Server 45 may perform multiple tests to determine if the constraint is met. In an example, server 45 makes the determination based on the current time and any other appointments that may have been scheduled during the time range. In the example, server 45 may determine (i) if, after scheduling other appointments during the time range, the unscheduled time is only able to accommodate the calendar appointment and no other calendar appointments, or (ii) if the current time has progressed/advanced relative to the time range such that the unscheduled time therein is only able to accommodate the calendar appointment and no other calendar appointments. In the example, the constraint is met if either of tests (i) or (ii) is met, and not met only if both of tests (i) and (ii) are not met.

At 430, if it is determined that the constraint is not met, server 45 delays scheduling of the appointment (until the constraint is met). Flow is directed to 415, whereupon server 45 repeats operations 415, 420, and 425. On the other hand, if the constraint is met, flow proceeds to 435.

At 435, server 45 automatically schedules the appointment at the future start time based on the met constraint and the calendar rule. Server 45 automatically schedules the appointment without any further user input.

At 440, a message is presented to the user indicating that the appointment has been scheduled and the future time for which the appointment was scheduled.

Optionally, at 445, after server 45 has automatically scheduled the appointment, the server may detect that at least one of the constraints is no longer met (e.g., becomes removed or invalidated). In response, server 45 un-schedules the automatically scheduled calendar appointment, thus returning the appointment to its original, unscheduled state, and flow returns to 415.

Turning to FIG. 5, an example block diagram is shown for server 45 on which the appointment engine 20 and other functions may be running. The server 45 includes a network interface unit 500 configured to enable network communications to send messages to and receive messages from, e.g., web browsers, of user devices. One or more processors 510 are provided that execute software stored in memory 520. The processor(s) 510 is, for example, a microprocessor or microcontroller. To this end, the memory 520 stores instructions for appointment engine software 530 (i.e., Partially Constrained Calendaring logic). When the one or more processors 510 execute the appointment engine software 530, the server 45 performs the operations described herein in connection with FIGS. 1-5.

Memory 520 may comprise read only memory (ROM), random access memory (RAM), magnetic disk storage media devices, optical storage media devices, flash memory devices, electrical, optical, or other physical/tangible memory storage devices. Thus, in general, the memory 520 may comprise one or more tangible (non-transitory) computer readable storage media (e.g., a memory device) encoded with software comprising computer executable instructions and when the software is executed (by the processor(s) 510) it is operable to perform the operations described herein.

In summary, in one form, a method is provided comprising: receiving partially constrained calendar rules at a current time for a calendar appointment to be scheduled at a future start time; determining as the current time advances whether a constraint based on the calendar rules is met; if it is determined that the constraints are not met, delaying scheduling of the calendar appointment until it is determined that the constraints are met; and if it is determined that the constraints are met, automatically scheduling the calendar appointment at the future start time based on the met constraint and the calendar rules.

In summary, in another form, an apparatus is provided comprising: a network interface unit configured send and receive communications over a network; a memory; and a processor coupled to the network interface unit and to the memory, and configured to: receive partially constrained calendar rules at a current time for a calendar appointment to be scheduled at a future start time; determine as the current time advances whether a constraint based on the calendar rules is met; if it is determined that the constraints are not met, delay scheduling of the calendar appointment until it is determined that the constraints are met; and if it is determined that the constraints are met, automatically schedule the calendar appointment at the future start time based on the met constraint and the calendar rules.

In summary, in yet another form, a computer readable storage media is provided. The storage media stores instructions that when executed by the processor cause the processor to: receive partially constrained calendar rules at a current time for a calendar appointment to be scheduled at a future start time; determine as the current time advances whether a constraint based on the calendar rules is met; if it is determined that the constraints are not met, delay scheduling of the calendar appointment until it is determined that the constraints are met; and if it is determined that the constraints are met, automatically schedule the calendar appointment at the future start time based on the met constraint and the calendar rules.

The above description is intended by way of example only.

What is claimed is:

1. A method comprising:
receiving partially constrained calendar rules at a current time for a calendar appointment to be scheduled at a future start time;
determining as the current time advances whether constraints based on the calendar rules are met;
if it is determined that the constraints are not met, delaying scheduling of the calendar appointment until it is determined that the constraints are met; and
if it is determined that the constraints are met, automatically scheduling the calendar appointment at the future start time based on the met constraints and the calendar rules.

2. The method of claim 1, wherein:
the receiving includes receiving, as the calendar rules, a duration of the calendar appointment and a future time range of initially unscheduled time available for future scheduling that is greater than the duration such that the future time range of initially unscheduled time is able to accommodate scheduling therein of the calendar appointment and one or more other calendar appointments.

3. The method of claim 2, wherein:
the determining includes determining as the current time advances whether unscheduled time in the time range is only able to accommodate the calendar appointment and no further calendar appointments;
if it is determined that the unscheduled time is not only able to accommodate the calendar appointment and no other calendar appointments, delaying scheduling of the calendar appointment; and
if it is determined that the unscheduled time is only able to accommodate the calendar appointment and no other calendar appointments, automatically scheduling the calendar appointment in the unscheduled time.

4. The method of claim 3, further comprising, prior to the determining: permitting scheduling of one or more other calendar appointments during the time range while the unscheduled time therein is able to accommodate both the calendar appointment and the one or more other calendar appointments.

5. The method of claim 4, wherein the determining includes determining, after scheduling one or more other calendar appointments during the time range, whether unscheduled time remaining therein is only able to accommodate the calendar appointment and no other calendar appointments.

6. The method of claim 5, wherein the determining further includes determining if the current time has advanced relative to the unscheduled time in the time range so that unscheduled time remaining therein is only able to accommodate the calendar appointment and no other calendar appointments.

7. The method of claim 3, wherein the determining includes:
determining, after scheduling one or more other calendar appointments during the time range, whether unscheduled time remaining therein is only able to accommodate the calendar appointment and no other calendar appointments; and
determining if the current time has advanced relative to the unscheduled time in the time range so that the unscheduled time remaining therein is only able to accommodate the calendar appointment and no other calendar appointments.

8. The method of claim 2, wherein:
the receiving includes receiving an indication that the future time is flexible and that the duration is not flexible; and
responsive to the received indication, performing the determining, the delaying, and the automatically scheduling.

9. The method of claim 2, wherein the receiving includes receiving an indication that one of the future time, a location associated with the calendar appointment, and the duration is flexible.

10. The method of claim 1, further comprising: after the scheduling, presenting a message indicating that the calendar appointment has been scheduled and the future time at which the calendar was scheduled.

11. The method of claim 1, further comprising: after the automatically scheduling:
detecting that at least one of the constraints is no longer met; and
responsive to the detecting, un-scheduling the automatically scheduled calendar appointment.

12. An apparatus comprising:
a network interface unit configured send and receive communications over a network;
a memory; and
a processor coupled to the network interface unit and to the memory, and configured to:
receive partially constrained calendar rules at a current time for a calendar appointment to be scheduled at a future start time;
determine as the current time advances whether constraints based on the calendar rules are met;
if it is determined that the constraints are not met, delay scheduling of the calendar appointment until it is determined that the constraints are met; and
if it is determined that the constraints are met, automatically schedule the calendar appointment at the future start time based on the met constraints and the calendar rules.

13. The apparatus of claim 12, wherein:
the processor is configured to receive by receiving, as the calendar rules, a duration of the calendar appointment and a future time range of initially unscheduled time available for future scheduling that is greater than the duration such that the future time range of initially unscheduled time is able to accommodate scheduling therein of the calendar appointment and one or more other calendar appointments.

14. The apparatus of claim 13, wherein the processor is further configured to:
determine as the current time advances whether unscheduled time in the time range is only able to accommodate the calendar appointment and no further calendar appointments;
if it is determined that the unscheduled time is not only able to accommodate the calendar appointment and no other calendar appointments, delay scheduling of the calendar appointment; and
if it is determined that the unscheduled time is only able to accommodate the calendar appointment and no other calendar appointments, automatically schedule the calendar appointment in the unscheduled time.

15. The apparatus of claim 14, wherein the processor is further configured to, prior to the determine operation: permit scheduling of one or more other calendar appointments during the time range while the unscheduled time therein is able to accommodate both the calendar appointment and the one or more other calendar appointments.

16. The apparatus of claim 15, wherein the processor is configured to determine by determining, after scheduling one or more other calendar appointments during the time range, whether unscheduled time remaining therein is only able to accommodate the calendar appointment and no other calendar appointments.

17. The apparatus of claim 14, wherein the processor is configured to determined by:
determining, after scheduling one or more other calendar appointments during the time range, whether unscheduled time remaining therein is only able to accommodate the calendar appointment and no other calendar appointments; and
determining if the current time has advanced relative to the unscheduled time in the time range so that the unscheduled time remaining therein is only able to accommodate the calendar appointment and no other calendar appointments.

18. A non-transitory computer readable storage media storing instructions that, when executed by a processor, cause the processor to:
receive partially constrained calendar rules at a current time for a calendar appointment to be scheduled at a future start time;
determine as the current time advances whether constraints based on the calendar rules are met;
if it is determined that the constraints are not met, delay scheduling of the calendar appointment until it is determined that the constraints are met; and
if it is determined that the constraints are met, automatically schedule the calendar appointment at the future start time based on the met constraints and the calendar rules.

19. The computer readable storage media of claim 18, further comprising instructions that cause the processor to:
the receive, as the calendar rules, a duration of the calendar appointment and a future time range of initially unscheduled time available for future scheduling that is greater than the duration such that the future time range of initially unscheduled time is able to accommodate scheduling therein of the calendar appointment and one or more other calendar appointments.

20. The computer readable storage media of claim 19, further comprising instructions that cause the processor to:
to determine as the current time advances whether unscheduled time in the time range is only able to accommodate the calendar appointment and no further calendar appointments;
if it is determined that the unscheduled time is not only able to accommodate the calendar appointment and no other calendar appointments, delay scheduling of the calendar appointment; and
if it is determined that the unscheduled time is only able to accommodate the calendar appointment and no other calendar appointments, automatically schedule the calendar appointment in the unscheduled time.
